(19) United States
(12) Patent Application Publication
(10) Pub. No.: US 2008/0085459 A1
(43) Pub. Date: Apr. 10, 2008

(54) ELECTROPHOTOGRAPHIC PHOTOCONDUCTOR, AND ELECTROPHOTOGRAPHIC APPARATUS

(76) Inventors: Hidetoshi Kami, Numazu-shi (JP); Tetsuro Suzuki, Fuji-shi (JP); Hiroshi Tamura, Susono-shi (JP); Hiroshi Ikuno, Yokohama-shi (JP); Yukio Fujiwara, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/855,510

(22) Filed: Sep. 14, 2007

(30) Foreign Application Priority Data
Sep. 15, 2006 (JP) 2006-250440

(51) Int. Cl. G03G 15/04

(52) U.S. Cl. 430/66

(57) ABSTRACT

There is provided an electrophotographic photoconductor which contains at least a conductive substrate, a photoconductive layer comprising a charge generating material and charge transport material, and a surface layer disposed on the photoconductive layer, disposed in this order, wherein the surface layer is a cross-linked resin which contains at least trimethylolpropane triacrylate, a charge transport material having a heat-curable or radical-polymerizable functional group, a silicone compound having a radical-polymerizable functional group, a fluorinated surfactant having a radical-polymerizable functional group, and a silicone compound removing material having a radical-polymerizable functional group having a wettability of 55 mN/m or more to less than 65 mN/m with the silicone compound.

### BACKGROUND OF THE INVENTION

1. Field of the Invention

The present invention relates to an electrophotographic photoconductor for use in copying machines, facsimiles, laser printers, direct digital printing plate forming machines and the like, and to a process cartridge for electrophotography, and an electrophotographic apparatus.

2. Description of the Related Art

Over ten years have passed since a plan of action “Agenda 21” established with hope for handing the rich global environment on to the next generation was adopted, and public awareness towards the environmental conservation has considerably deepened.

For example, separation of recyclables from non-recyclables and frequent use of the blank sides of used sheets of paper as printer sheets are examples of immediate change in awareness.

Today, the environmental performance of an industrial product has been generally emphasized such that it influences the future of the product.

Under such circumstances, research and development of an electrophotographic photoconductor aimed for reducing the effects on the environment have vigorously been made.

In view of a life cycle of an electrophotographic photoconductor from raw material mining to disposal, it is primarily necessary to promote an increase in the lifetime and improvement safety to human body.

The usage pattern of an electrophotographic photoconductor still has a strong aspect as a disposable supply product and therefore there is still room for improvement in terms of resource saving and waste reduction.

In response to this, it is required to suppress the abrasion and scratches on a photoconductor to thereby improve durability of the photoconductor, in view of design and usage thereof.

An amorphous silicone photoconductor is a typical heavy-duty photoconductor today.

However, the production cost of the amorphous silicone photoconductor is high since the manufacturing method thereof is a dry process, and it is used only for high-end products with some exceptions. The contribution of the high durability of the amorphous silicone conductor to the reduction of environmental burdens is considered insufficient since the use ratio of the amorphous silicone conductor is small.

In order to achieve the reduction of environmental burdens, it is desirable that the durability of the photoconductor is enhanced as well as the cost is reduced to increase the use ratio. To achieve this, it is advantageous to increase the durability of a low-cost organic photoconductor.

To achieve an improvement in durability of an organic photoconductor, there have been taken the following measures: change of a binder resin in a charge transport layer of a photoconductor (e.g., see Hiroyuki Tamura, Saeko Takahashi, Hironobu Morishita, Hideharu Sakamoto, Haruo Shikuma, Japan Hardcopy '97 Fall Meeting 25-28, 1997); high-molecular weight type charge transport material (see, e.g., Japanese Patent Application Laid-Open (JP-A) No. 07-325409); coating of a curable protection layer including a high-hardness filler (see, e.g., Japanese Patent Application Laid-Open (JP-A) No. 2002-258499); formation of a cross-linked resin film on the surface of a photoconductor (see, e.g., Japanese Patent Application Laid-Open (JP-A) No. 2000-66424); and formation of a sol-gel curable film on the surface of a photoconductor (see, e.g., Japanese Patent Application Laid-Open (JP-A) No. 2000-171990).

The abovementioned measures have advantages and disadvantages. In particular, in the last two measures in which a cross-linked structure is formed, a coated film is formed by a plurality of chemical bonds, so that even when a stress is applied to the coated film to dissociate a part of the chemical bonds, abrasion does not occur immediately. Therefore, among the abovementioned measures, the last two adopting a cross-linked structure can be considered to be pretty reasonable solutions. The measures concerning the last two solutions are collectively referred to as “curable type protection layer” for the shake of convenience.

When an extremely-high abrasion resistance is given to a photoconductor, scratch resistance equivalent to the increase in the abrasion resistance is required. Because, when the surface of the photoconductor is scratched, the electrical discharge hazard in an electrophotographic process concentrates in the scratched portions and alters them.

Also, grooves formed by the scratches are embedded with a toner component or paper powder, and thus, local image deficiencies such as background smear and blur tend to occur. As the abrasion resistance further improves, a scratch once occurred cannot easily disappear with time as if it is engraved. As a result, the scratches inhibit the longer operating life of the photoconductor.

In recent years, full-color electrophotographic devices mainly use a polymerization toner because of increase in image quality and environmental performance. The sharpness of an image is increased as the spherical degree of the polymerization toner becomes higher. On the other hand, in a system where a toner is collected using a cleaning blade, a possibility that a toner passes through the blade becomes higher. This results in a stripe-like image noise as a malfunction of the electrophotographic devices.

In order to cope with this, a silica powder is mixed with a toner such that the toner is blocked by the blade portion, thereby ensuring toner cleaning function (see, e.g., Japanese Patent Application Laid-Open (JP-A) No. 2002-318467).

In an electrophotographic device in which the photoconductor with a high-abrasion resistance is used in combination with the special polymerization toner with which the silica powder is mixed is used, the silica may cause scratches on the surface of the photoconductor, or silica itself may stick to the photoconductor surface and deposited thereon. FIG. 9, which is a profile curve obtained by measurement of the surface roughness of the photoconductor, schematically shows this state as a representative example. As a result, advantage of the abrasion resistance property of the photoconductor cannot be exploited.

For example, a technique in which the surface energy of a photoconductor is lowered to increase a releasing property between the silica and photoconductor surface to thereby prevent scratches or filming of the silica on the photoconductor surface from occurring has been proposed (see, e.g., Japanese Patent Application Laid-Open (JP-A) No. 2005-62830).

However, application of this technique often degrades the abrasion resistance property. Although a photoconductor with a high-abrasion resistance property is required to maintain a surface smoothing property against the filming or scratches in order to maintain stable toner cleaning performance, there has not yet appeared a technique to cope with this issue.

### BRIEF SUMMARY OF THE INVENTION

An object of the present invention is to solve the above conventional problems and to achieve the following objects. That is, the present invention aims at providing an electrophotographic photoconductor capable of forming a high-quality color image, with an extremely high-abrasion resistance, as well as maintaining a good surface smoothing property.

As a result of the present inventors' studies devoted to achieve the aforementioned object, it was found that it is effective to employ an electrophotographic photoconductor having a radical polymerization-curable film as a surface layer containing a cross-linked resin obtained by curing trimethylolpropane triacrylate, a charge transport material having a heat-curable or radical-polymerizable functional group, a silicone compound having a radical-polymerizable functional group, and a lubricant for removing the silicone compound which allows the silicone compound to be constantly disposed on the surface in a biased manner and has a radical-polymerizable functional group having a wettability of 55 mN/m or more to less than 65 mN/m with the silicone compound.

The present invention has been made based on the abovementioned finding, and means for solving the above object are as follows.

An electrophotographic photoconductor according to the present invention has at least a conductive substrate, a photoconductive layer containing a charge generating material and charge transport material, and a surface layer, disposed in this order. The surface layer is a cross-linked resin which at least contains: trimethylolpropane triacrylate; a charge transport material having a heat-curable or radical-polymerizable functional group; a silicone compound having a radical-polymerizable functional group; a fluorinated surfactant having a radical-polymerizable functional group; and a silicone compound removing material having a radical-polymerizable functional group having a wettability of 55 mN/m or more to less than 65 mN/m with the silicone compound.

A process cartridge according to the present invention has at least an electrophotographic photoconductor disposed therein. The electrophotographic photoconductor has at least a conductive substrate, a photoconductive layer containing a charge generating material and charge transport material, and a surface layer, disposed in this order. The surface layer is a cross-linked resin which at least contains: trimethylolpropane triacrylate; a charge transport material having a heat-curable or radical-polymerizable functional group; a silicone compound having a radical-polymerizable functional group; a fluorinated surfactant having a radical-polymerizable functional group; and a silicone compound removing material having a radical-polymerizable functional group having a wettability of 55 mN/m or more to less than 65 mN/m with the silicone compound.

An electrophotographic apparatus according to the present invention has at least: an electrophotographic photoconductor; and a process cartridge disposing the electrophotographic photoconductor therein. The electrophotographic photoconductor has at least a conductive substrate, a photoconductive layer containing a charge generating material and charge transport material, and a surface layer, disposed in this order. The surface layer is a cross-linked resin which contains at least: trimethylolpropane triacrylate; a charge transport material having a heat-curable or radical-polymerizable functional group; a silicone compound having a radical-polymerizable functional group; a fluorinated surfactant having a radical-polymerizable functional group; and a silicone compound removing material having a radical-polymerizable functional group having a wettability of 55 mN/m or more to less than 65 mN/m with the silicone compound.

### BRIEF DESCRIPTION OF THE SEVERAL VIEWS OF THE DRAWINGS

FIG. 1 is a cross-sectional view showing an exemplified configuration of an electrophotographic apparatus according to the present invention;

FIG. 2 is a view showing another example of an electrophotographic process according to the present invention;

FIG. 3 is a cross-sectional view showing an exemplified configuration of a process cartridge according to the present invention;

FIG. 4 is a cross-sectional view of an exemplified configuration of the electrophotographic apparatus according to another embodiment of the present invention;

FIG. 5 is a cross-sectional view of an exemplified configuration of the electrophotographic apparatus according to still another embodiment of the present invention;

FIG. 6 is a cross-sectional view of an exemplified configuration of the electrophotographic apparatus according to yet still another embodiment of the present invention;

FIG. 7 is a cross-sectional view showing an example of a layer structure of an electrophotographic photoconductor according to the present invention;

FIG. 8 is a cross-sectional view showing an example of a layer structure of an electrophotographic photoconductor according to another embodiment of the present invention; and

FIG. 9 shows an example of a profile curve of a photoconductor obtained by surface roughness measurement.

### DETAILED DESCRIPTION OF THE INVENTION

An electrophotographic photoconductor of the present invention will be described in details below with reference to the accompanying drawings.

FIG. 7 is a cross-sectional view schematically showing an example of an electrophotographic photoconductor having a layer structure. As shown in FIG. 7, an electrophotographic photoconductor of the present invention has, on a conductive substrate 21, a charge generating layer 25, a charge transport layer 26, and a curable type protective layer 28.

FIG. 8 is a cross-sectional view showing an example of a layer structure of an electrophotographic photoconductor according to another embodiment of the present invention. As compared with the configuration of FIG. 7, this electrophotographic photoconductor of FIG. 8 further has an underlying layer 25 between the conductive substrate 21 and charge generating layer 22. Further, the charge transport layer 26 and curable type protective layer 28 are provided on the charge generating layer 22.

<Conductive Substrate>

As the conductive substrate 21, a conductive substrate obtained by applying to a film-shaped or cylindrical plastic or paper, a conductive material with a volumetric resistivity of 10¹⁰ Ω/cm or less, for example, a metal such as aluminum, nickel, chromium, nichrome, copper, gold, silver, and platinum, and a metal oxide such as tin oxide and indium oxide by means of vapor-depositing or sputtering, a conductive plate made of aluminum, aluminum alloy, nickel, or stainless, and a conductive pipe produced by applying surface treatment such as cutting, super finishing, and polishing to an unfinished pipe obtained by applying a drawing ironing method, impact ironing method, extruded ironing method, extruded drawing method, or cutting method to aluminum, aluminum alloy, nickel, or stainless can be used.

<Underlying Layer>

In the electrophotographic photoconductor according to the present invention, an underlying layer 24 may be provided between the conductive substrate body 21 and the photoconductive layer. The underlying layer 24 is provided for the purpose of increasing adhesiveness, preventing generation of a moire pattern, improving coating property of the upper layer, and preventing charge injection from the conductive substrate body 21.

Typically, the underlying layer 24 includes a resin. Since a photoconductive layer is coated on the underlying layer 24, it is preferable to use a thermosetting resin having a low solubility in an organic solvent as the resin used for the underlying layer 24. As the thermosetting resin, polyurethane, melamine resin, alkyd-melamine resin, and the like are preferably used. The abovementioned resins each can be appropriately diluted in a solvent such as tetrahydrofuran, cyclohexanone, dioxane, dichloroethane, or butanone, and used as a coating liquid.

In addition, a fine particle of a metal or a metal oxide, may be added into the underlying layer 24 for controlling conductivity and preventing generation of a moire pattern. As the fine particle, titanium oxide is particularly preferably used.

The above-mentioned fine particle is dispersed in a solvent such as tetrahydrofuran, cyclohexanone, dioxane, dichloroethane, or butanone, using a ball mill, attriter, sand mill, etc. The resultant liquid is mixed with a resin component to obtain a coating liquid.

The obtained coating liquid is coated on the conductive substrate body 21 by a dip coating method, spray coating method, bead coating method, etc. for film formation followed by heat curing according to the need, whereby the underlying layer 24 is obtained.

In most case, the film thickness of the underlying layer 24 is preferably 2 μm to 5 μm. In the case where accumulation of a residual potential of the photoconductor becomes large, the film thickness of the underlying layer 24 is set to less than 3 μm.

A photoconductive layer of the present invention is preferably a multilayered photoconductive layer obtained by sequentially laminating the charge generating layer and charge transport layer.

<Charge Generating Layer>

The charge generating layer 25 constituting the multilayered photoconductive layer will be described.

The charge generating layer 25 serves as a part of the multilayered photoconductive layer and has a function of generating a charge by exposure.

The charge generating layer 25 contains at least a charge generating material.

The charge generating layer 25 may contain a binder resin according to the need.

At least any one of an inorganic material and an organic material can be used as the charge generating material.

The multilayered inorganic material may be crystal selenium, amorphous selenium, selenium-tellurium, selenium-tellurium-halogen, selenium-arsenic compound, and amorphous silicone, etc.

With respect to amorphous silicone, amorphous silicone in which dangling bond is terminated by hydrogen atom or halogen atoms or in which boron atom or phosphorus atom are doped, is used well.

As for the organic material, a well-known material can be used. For example, metal phthalocyanine such as titanylphthalocyanine and chlorogalliumphthalocyanine, metal-free phthalocyanine, an azulenium salt pigment, a squaric acid methine pigment, a symmetric or an asymmetric azo pigment having a carbazole skeleton, a symmetric or an asymmetric azo pigment having a triphenyl amine skeleton, a symmetric or an asymmetric azo pigment having a fluorenone skeleton, perylene pigments, etc. can be used.

Of these materials, metal phthalocyanine, a symmetric or an asymmetric azo pigment having a fluorenone skeleton, a symmetric or an asymmetric azo pigment having a triphenyl amine skeleton, and perylene pigments each have high quantum efficiency upon charge generation and preferably used in the present invention. The abovementioned charge generating materials may be utilized independently or as a mixture of more than one kind thereof.

As the binder resin used for the charge generation layer 25 according to need, polyamide, polyurethane, epoxy resin, polyketone, polycarbonate, polyarylate, silicone resin, acrylic resin, polyvinyl butyral, polyvinyl formal, polyvinyl ketone, polystyrene, poly-N-vinylcarbazole, and polyacrylamide can be provided. The binder resin may contain a polymeric charge transport material to be described later.

Of these materials, polyvinyl butyral is used frequently and is useful. The binder resins can be used singularly or in combination as a mixture.

Typical methods of forming the charge generating layer are a vacuum thin-film producing method and a casting method from a solution dispersion system.

The vacuum thin-film producing method may be any one of vacuum evaporation, glow discharge decomposition, ion plating, sputtering, reactive sputtering, CVD (Chemical Vapor Deposition), which can desirably form the charge generating layer 25 containing the inorganic and organic materials as a charge generating material.

To form the charge generating layer by the casting method, there may be executed the steps of dispersing the inorganic or organic charge generating material with or without the binder resin in tetrahydrofuran, cyclohexanone, dioxane, dichloroethane, butanone or similar solvent by use of a ball mill, an atriter or a sand mill, suitably diluting the dispersion liquid, and coating the diluted liquid.

Methylethylketone, tetrahydrofuran, and cyclohexanone used as the solvent produce less environmental burdens than chlorobenzene, dichloroethane, toluene, and xylene and, therefore, are preferably used. The coating can be carried out by a dip coating method, spray coating method, bead coating method, etc.

The film thickness of the charge generating layer formed by the above procedure should preferably be 0.01 μm to 5 μm.

There may be a case where it is necessary to reduce a residual potential and to increase sensitivity. In such a case, when the film thickness of the charge generating layer is increased, theses properties are often improved. At the same time, however, charging capability may often deteriorated, which lowers charging retention capability and forms a space charge. In consideration of the balance between the above-mentioned properties, the thickness is more preferably in a range of from 0.05 μm to 2 μm.

If necessary, antioxidant, plasticizer, lubricant, ultraviolet absorber or similar low molecular compound and a leveling agent to be described later may be added to the charge generating layer 25.

These compounds can be used singularly or in combination as a mixture.

There is often the case where simultaneous use of a low molecular compound and leveling agent deteriorates the sensitivity. Therefore, the used amount of the compounds is preferably in a range from 0.1 phr to 20 phr, more preferably 0.1 phr to 10 phr. The used amount of the leveling agent is preferably in a range from 0.001 phr to 0.1 phr.

<Charge Transport Layer>

The charge transport layer, which serves as a part of the multilayered photoconductive layer, injects and transports a charge generated in the charge generating layer to thereby neutralize a surface charge of a photoconductor which is produced by electrification.

The charge transport layer contains at least a charge transport component and a binder component for binding the charge transport component.

As the charge transport material, a low-molecular type electron transport material, hole transport material, and high molecular charge transport material can be used.

Examples of the low-molecular type electron transport material include an electron acceptable material such as an asymmetric diphenoquinone derivative, a fluorene derivative, and a naphthalimido derivative. These electron transport materials can be used singularly or in combination as a mixture.

As the hole transport material, it is preferable to use an electron releasing material.

Examples of the hole transport material include an oxazole derivative, oxadiazole derivative, imidazole derivative, triarylamine derivative, butadiene derivative, 9-(p-diethylaminostyrylanthracene), 1,1-bis-(4-dibenzylaminophenyl)propane, styrylanthracene, styrylpyrazoline, phenylhydrazones, α-phenylstilbene derivative, thiazole derivative, triazole derivative, phenazine derivative, acridine derivative, benzofuran derivative, benzimidazole derivative, and thiophene derivative.

These hole transport material can be used singularly or in combination as a mixture.

Examples of the high molecular charge transport material include polymers having carbazole ring, such as poly-N-vinylcarbazole, polymers having hydrazone structure exemplified in Japanese Patent Application Laid-Open No. 57-78402, polysilylene polymers exemplified in Japanese Patent Application Laid-Open No. 63-285552, and aromatic polycarbonate exemplified by general formulas (1) to (6) in Japanese Patent Application Laid-Open No. 2001-330973. These high polymer charge transport materials can be used singularly or in combination as a mixture. In particular, the compounds exemplified in JP-A No. 2001-330973 have excellent electrostatic characteristics and therefore useful.

When the high molecular charge transport material is used to laminate curable protection layer, the component constituting the charge transport layer hardly comes out to the surface layer as compared to the case where the low molecular charge transport material is used. Thus, the high molecular charge transport material is suitable for preventing poor curing. Further, increased molecular weight of the charge transport material increases heat resistance and, therefore, the high molecular charge transport material is advantageous in that it undergoes less deterioration due to heat for curing treatment during formation of the curable protection layer.

The high molecular compound that can be used as the binder component of the charge transport layer may be any one of thermoplastic or thermosetting resins including polystyrene, polyester, polyvinyl, polyarlylate, polycarbonate, acrylic resin, silicone resin, fluorine resin, epoxy resin, melamine resin, urethane resin, phenol resin and alkyd resin.

Among them, polystyrene, polyester, polyarlylate, polycarbonate exhibit a high charge mobility as a binder component of the charge transport layer and are useful.

Since a curable protection layer or protection layer is laminated on the upper layer of the charge transport layer, a higher mechanical strength of the charge transport layer is not required as compared to a conventional charge transport layer. Therefore, it is possible to use, as a binder component of the charge transport layer, a material having a higher transparency but a little lower mechanical strength, such as polystyrene, which has been conventionally difficult to use.

These high molecular compounds may be used either singly or in combination, may used as a copolymer containing two or more of raw material monomers of these compounds, or may be copolymerized with the charge transport material.

Electrically inactive high molecular compounds may be used for the modification of the charge transport layer. Suitable examples of such electrically inactive high molecular compounds are polyesters having a cardo structure and containing a bulky skeleton such as fluorene; polyesters such as polyethylene terephthalates and polyethylene naphthalates; polycarbonate derivatives derived from bisphenol polycarbonates such as C type polycarbonates, except with 3,3′-positions of the phenol moiety substituted with alkyls; polycarbonate derivatives derived from bisphenol A, except with a geminal methyl group of bisphenol A substituted with a long-chain alkyl group having two or more carbon atoms; polycarbonates having a biphenyl skeleton or a biphenyl ether skeleton; polycarbonates having a long-chain alkyl skeleton such as polycaprolactones as disclosed in JP-A No. 7-292095; acrylic resin; polystyrenes; and hydrogenated polybutadienes.

The electrically inactive high molecular compounds herein refer to high molecular compounds having no chemical structure that exhibits photoconductivity, such as a triarylamine structure.

The amount of such high molecular compounds, if used as an additive in combination with the binder resin, is preferably 50% by mass or less with respect to the total solids mass of the charge transport layer for limitations in optical-attenuation sensitivity.

The use amount of the low-molecular charge transport material, if used as the charge transport material, is preferably from about 40 phr to about 200 phr, and more preferably from about 70 phr to about 100 phr.

As the polymeric charge transport material, preferred is a copolymer of preferably 0 to 200 parts by mass, and more preferably 80 parts by mass to 150 parts by mass of a resin component with 100 parts by mass of the charge transport material.

When two or more charge transport materials are incorporated into the charge transport layer, it is preferred that a difference in ionization potential between the two charge transport materials be 0.10 eV or less for reasons that one of them would not act as a charge trap material for the other.

Likewise, it is preferred that a difference in ionization potential between the charge transport material incorporated into the charge transport layer and a curable charge transport material to be described later be 0.10 eV.

The ionization potential value of the charge transport material in the present invention was measured according to a typical method by means of a UV photoelectron analyzer AC-1 (made by Riken Keiki Co., Ltd.) in the atmosphere.

The content of the charge transport material is preferably set to 70 phr or more for higher photosensitivity. The charge transport material is preferably one of monomers and dimers of α-phenylstilbene compounds, benzidine compounds or butadiene compounds, and high molecular charge transport materials having any of these structures in their principal chain or side chain, since most of these materials have a high charge mobility.

As a dispersion solvent for preparing the charge transport layer coating liquid, ketones such as methyl ethyl ketone, acetone, methyl isobutyl ketone, and cyclohexanone; ethers such as dioxane, tetrahydrofuran, ethylcellosolve and the like; aromatic compounds such as toluene, xylene and the like; halogens such as chlorobenzene, dichloromethane and the like; esters such as ethyl acetate, butyl acetate and the like are used. Among them, methylethylketone, tetrahydrofuran, and cyclohexanone produce less environmental burdens than, chlorobenzene, dichloromethane, toluene, and xylene and, therefore, are preferably used. These solvents can be used singularly or in combination as a mixture.

The charge transport layer can be prepared by dissolving or dispersing a mixture or a copolymer mainly including a charge transport material and a binder component in a suitable solvent to form a coating composition, applying and then drying the coating composition. The coating composition can be applied typically by dipping, spray coating, ring coating, roll coating, gravure coating, nozzle coating or screen printing.

The charge transport layer in the present invention is covered by the curable protection layer, and the film thickness thereof can be reduced to some extent, since reduction in film thickness in actual use is trivial.

The film thickness of the charge transport layer is preferably from about 10 μm to about 40 μm and more preferably from about 15 μm to about 30 μm for ensuring practically satisfactory photosensitivity and charge ability.

If necessary, the charge transport layer may further contain any additives including low-molecular compounds such as antioxidants, plasticizers, lubricants and UV absorbers, as well as leveling agents. Each of these additives can be used alone or in combination. When such a low-molecular compound and a leveling agent are incorporated into the charge transport layer, the photosensitivity may often be deteriorated. To avoid this, the use amount of these low-molecular compounds is preferably from about 0.1 phr to about 20 phr and more preferably from about 0.1 phr to about 10 phr. The amount of the leveling agent is preferably from about 0.001 phr to about 0.1 phr.

[Surface Layer]

A surface layer is a protection layer formed on the surface of the photoconductor. After the coating liquid of the surface layer is coated, a polycondensation reaction occurs to form a cross-linked resin. Since the resin film has a cross-linking structure, it is preferable that the surface layer have the highest abrasion resistance among the other layers constituting the photoconductor. When blended with a charge transport material having a cross-linking property, the surface layer exhibits similar charge mobility to the charge transport layer. Hereinafter, the surface layer according to the present invention is sometimes referred to as “cross-linked resin surface layer”.

The surface layer according to the present invention is a cross-linked resin obtained by curing at least a radical-polymerizable monomer having no charge transporting structure, a charge transport material having a heat-curable or radical-polymerizable functional group, a silicone compound having a radical-polymerizable functional group, a fluorinated surfactant having a radical-polymerizable functional group, a silicone compound removing material having a radical-polymerizable functional group having a wettability of 55 mN/m or more to less than 65 mN/m with the silicone compound.

<Radical-Polymerizable Monomer Having No Charge Transporting Structure>

As a trifunctional or more radical-polymerizable monomer having no charge transporting structure, it is preferable to use compounds described in paragraph [0022] in Japanese Patent Application Laid-Open No. 2004-302451. Among these, trimethylolpropane triacrylate, caprolactone-modified dipentaerithritol hexaacrylate, and dipentaerithritol hexaacrylate are particularly preferable. These materials are available from manufacturers of laboratory chemicals in Japan, such as Tokyo Chemical Industry Co., Ltd., Japan and from KAYARD DPCA series, KAYARD DPHA series manufactured by Nippon Kayaku Co., Ltd., An initiator such as IRGACURE 184 (manufactured by Ciba specialty chemicals) may be added 5% by mass to 10% by mass based on the total solid content of the abovementioned compound.

<Binder Component>

Further, as a trifunctional or more binder component, caprolactone-modified dipentaerithritol hexaacrylate, or dipentaerithritol hexaacrylate may be used. This increases abrasion resistance and strength of the cross-linked film itself.

(Silicone Compound Having Radical-Polymerizable Functional Group)

Examples of the silicone compound include, e.g., X-22-164A (molecular weight: 860), X-22-164B (molecular weight: 1,630), X22-164C (molecular weight: 2,370), X-22-174DX (molecular weight: 4,600), X-24-8201 (molecular weight: 2,100), and X-22-2426 (molecular weight: 12,000) from Shin-Etsu Chemical Co., Ltd.; bi-terminal Silaplane FM-7711 having radical-polymerizable functional groups on both terminals thereof (molecular weight: 1,000), bi-terminal Silaplane FM-7721 (molecular weight: 5,000), bi-terminal Silaplane FM-7725 (molecular weight: 10,000), mono-terminal Silaplane FM-0711 (molecular weight: 1,000), mono-terminal Silaplane FM-0721 (molecular weight: 5,000), mono-terminal Silaplane FM-0725 (molecular weight: 10,000), mono-terminal Silaplane TM-0701 (molecular weight: 423), and mono-terminal Silaplane TM-0701T (molecule weight: 423) from Chisso Corporation; BYK-UV3500, BYK-UV3510 and BYK-UV3570 from BYK Japan K.K., and these are not limited thereto. These silicone compounds can be used alone or in combination.

The amount of the silicone compound is preferably from 0.5% by mass to 15% by mass, and more preferably from 1% by mass to 10% by mass with respect to a total solids mass of a coating liquid of the cross-linked surface layer.

When the amount of the silicon compound is less than 3% by mass, the cross-linked surface layer includes not enough lubricant in the cross-linked surface layer to have sufficiently low surface energy and good cleaning ability. When the amount of the silicone compound is greater than 30% by mass, it becomes difficult to obtain a coated film having a uniform and smooth surface.

(Silicone Compound Removing Material)

As the silicone compound removing material, known surfactant can be used in the present invention. Specific examples include (1) copolymers including (metha)acrylate having a fluoroalkyl group disclosed in paragraph [0017] of Japanese Patent Application Laid-Open No. 07-068398, such as block copolymers formed of a vinyl monomer not including a fluorine and a vinyl monomer including a fluorine disclosed in Japanese Patent Application Laid-Open Nos. 60-221410 and 60-228588; and (2) fluorinated graft polymers such as comb graft polymers copolymerized with a methacrylate macro monomer having polymethylmethacrylate in its side chain and (metha)acrylate having a fluoroalkyl group disclosed in Japanese Patent Application Laid-Open No. 60-187921.

These fluorine-containing resins are commercially available as coating additives. Specific examples of such coating additives are fluorine-containing random copolymers available as resin surface modifiers SC-101 and SC-105 from Asahi Glass Co., Ltd.

Specific examples of fluorine-containing block copolymers include block copolymers formed of a polymer segment including a fluorinated alkyl group and an acrylic polymer segment, such as a marketed Modiper F series from NOF Corporation (e.g., F100, F110, F200, F210 and F2020).

Specific examples of the fluorinated graft polymers include Aron Gf-150, GF-300, RESEDA GF-2000 marketed by To a gousei Co., Ltd. These surfactants are useful and can be used alone and can also be used as a cross-linked resin. Particularly, copolymers between methacrylate ester and fluoroalkyl acrylate are effectively used in the present invention.

These silicone removing materials may be utilized independently or as a mixture of more than one kind thereof. The amount of the silicone removing material is preferably from 0.5% by mass to 15% by mass, and more preferably from 1% by mass to 15% by mass with respect to the total solids mass of a coating liquid of the cross-linked surface layer.

When the amount of the silicone removing material is less than 1% by mass, it is impossible to constantly dispose the silicone compound on the surface in a biased manner to greatly vary the static friction coefficient of the photoconductor from about 0.1 to 0.5 depending on the conditions for use.

When the amount of the silicone removing material is greater than 15% by mass, the hardness of the surface layer may decrease, the surface smoothness at film formation time may be impaired, or deterioration of potential decay characteristics occurs due to electrical charge or exposure. Thus, the amount of the silicone removing material is preferably 15% by mass or less.

(Cross-Linked Charge Transport Material)

The cross-linked charge transport materials (curable type charge transport material) represented by the following general formulas 1 to 3 are advantageous not only in light attenuation characteristics and charging characteristics but also formation of a uniformly cured film.

When a coated film is obtained by radical polymerization, exposure by means of a metal halide lamp is an easy-to-use approach.

The charge transport material has little unnecessary light absorption in the exposure time, so that radical polymerization is not inhibited, ensuring the formation of a uniform film.

In order to develop a charge transport function, the amount of the charge transport material should be 5% by mass or more based on the total solids mass of the cross-linked resin surface layer. The upper limit of the content thereof should be less than 60% by mass in terms of cost or for suppressing deterioration of film strength.

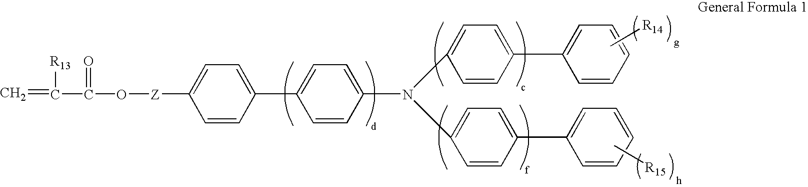

In the above general formula 1, “d,” “e” and “f” each represent an integer of 0 or 1, R¹³ represents a hydrogen atom, a methyl group, R₁₄ and R₁₅ represent a substituent other than a hydrogen atom which is a C1-6 alkyl group and may be different when they are two or more, “g” and “h” represent an integer of 0 to 3, and Z represents a single bond, a methylene group, an ethylene group, or a group expressed by the following formulae:

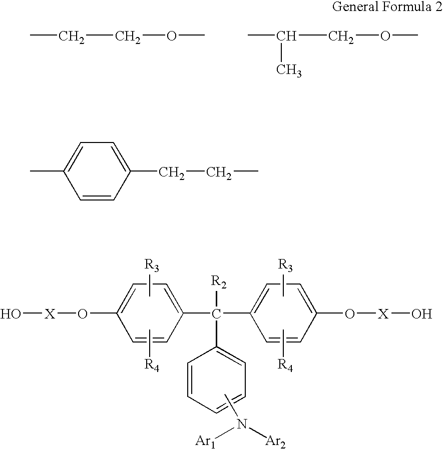

In the above general formula 2, R₂, R₃, and R₄ respectively represent hydrogen atom, substituted or unsubstituted alkyl group, or aryl group; Ar₁ and Ar₂ respectively represent aryl group; and X represents one of the following (a) to (d).

(a) alkylene group

(b) arylene group

(c) group represented by the following general formula 4

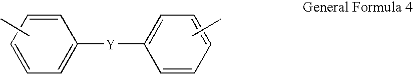

In this general formula 4, Y represents —O—, —S—, —SO—, —SO₂—, —CO—, and the following divalent group.

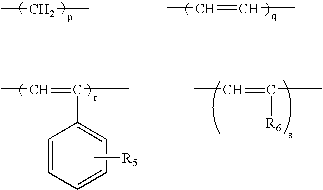

In the formulae above, R₅ and R₆ respectively represent hydrogen atom, alkyl group, alkoxy group, halogen atom, aryl group, amino group, nitro group, or cyano group, and p, q, r, s are each an integer from 1 to 12.

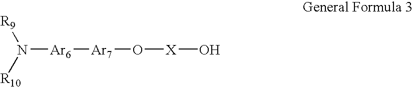

In this general formula 3, R₉ and R₁₀ respectively represent a substituted or unsubstituted aryl group. R₉ and R₁₀ may be the same or different. An arylene group represented by Ar₆ and Ar₇ is a divalent group of the same aryl group as R₉ and R₁₀, which may be same or different. Further, X is the same as that shown in the above general formula 2.

As a material of the cross-linked charge transport material, it is preferable to use a material excellent in injection of a charge from the underlying charge transport layer and having a high charge transport capability. In this relation, a charge transport monomer used in synthesizing a high-molecular charge transport material exemplified in Japanese Patent Application Laid-Open No. 2001-330937 has been extensively utilized and is very useful. A small amount of a material (equivalent weight) per functional group playing a major role in curing a molecular frame increases the content of a curing agent (contact material) in the curable resin surface layer, thereby limiting the maximum content of the curable charge transfer material. It is preferable to select a material having a high equivalent weight for convenience of formulation design. Specifically, it is preferable to select a material having an equivalent weight of 200 or more. In particular, a use of the compounds represented by the abovementioned general formulae 1 to 3 is rational.

Preferable examples of compound used as the cross-linked charge transport material in the formula 1 include: acrylic acid 4′-(di-p-tolylamino)biphenyl-4-yl-ester; 2-methyl-acrylic acid 4′(di-p-tolylamino)biphenyl-4-yl-ester; acrylic acid 4′-diphenylamino-biphenyl-4-yl-ester; and 2-methyl-acrylic acid 4′-diphenylamino-biphenyl-4-yl-ester.

Preferable examples of compound used as the cross-linked charge transport material in the formula 2 include: (4-[bis-(4-methoxyphenyl)-methyl]-diphenyl-amine; (4-[bis-(4-ethoxyphenyl)-methyl]-diphenyl-amine; (4-[bis-(4-methoxyphenyl)-methyl]-di-p-tolyl-amine; and (4-[bis-(4-ethoxyphenyl)-methyl]-di-p-tolyl-amine.

Preferable examples of compound used as the cross-linked charge transport material in the formula 3 include: 4′-[(di-p-tolylamino)-biphenyl-4-yl-oxy]-methanol; and 4′-[(di-p-tolylamino)-biphenyl-4-yl-oxy]-ethanol.

When a coated film is obtained by radical polymerization, exposure by means of a metal halide lamp is an easy-to-use approach. The charge transport material represented by the general formula 1 has little unnecessary light absorption in the exposure time, so that radical polymerization is not inhibited, ensuring the formation of a uniform film. In order to develop a charge transport function, the content of the charge transport material should be 5% or more by mass with respect to the total solids mass of the cross-linked resin surface layer. The upper limit of the content thereof should be less than 60% by mass in terms of cost or for suppressing deterioration of film strength.

As described above, an acrylic resin containing trimethylol propane triacrylate (TMPTA) exhibits high hardness. As a result, a photoconductor has an increased abrasion resistance.

A radical-polymerizable silicone compound allows the photoconductor surface to exhibit a low friction property.

It is known that a photoconductor containing, on the surface layer, a comparatively large amount of silicone oil at a several percent level, which has been used in the related art, exhibits a low friction property of less than 0.1 in terms of the initial friction coefficient.

However, this low friction property disappears immediately after use. It is considered that this is caused by disappearance of a low friction component due to bleed out of the silicone oil, migration of a silicone component into the bulk of the photoconductive layer, and breakage of silicone molecular chains.

The bread out of the silicone oil can be suppressed by the crosslinking. The molecular chains of the silicone component are partially broken by a load imposed thereon during a charging process. In the worst case, the low friction property of the surface disappears by the breakage. Thus, in order to develop the low friction property even when molecular chains are broken, it is advantageous, in terms of maintenance of the low friction property, to select a silicone compound having a molecular weight of 1,000 or more and having a plurality of radical polymerizable functional groups, such as (meta)acryloyl group, within one molecule.

Further, by incorporating a block (which is referred to as “silicone removing material” for the sake of simplicity) having a low affinity with a silicone segment in the cross-linked resin, it is possible to accelerate the deposition rate of the silicone to the surface.

In the present invention, it is important to incorporate a curable silicone removing material in the cross-linked resin on the photoconductor surface. It is advantageous to select a combination of a silicone compound and silicone removing material each having a low solubility in each other based on the matching of solubility parameter (SP) value or equivalent. In addition, however, the combination can be experimentally selected based on the wettability between the two materials according to extended Forkes's theory which is obtained by contact angle measurement.

Specifically, the surface free energy (γ) of a silicone compound film by itself is about 40 mN/m. The breakdown of the above surface free energy is as follows: the surface free energy of non polar component (γ^{a}) is 35 mN/m, that of polar component (γ^{b}) is 4 mN/m, and that of hydrogen-bonding component (γ^{c}) is 0 mN/m. The wettability (W) between the silicone compound film and fluorinated surfactant is 65 mN/m. This means the initial object can be achieved.

As a result, the surface of the photoconductor exhibits an improved abrasion resistance and scratch resistance. In addition, a disadvantage called filming due to adhesion of foreign matters hardly occurs. In particular, since the photoconductor surface maintains its smoothness and exhibits a low friction property, it has good cleanability of a polymerization toner.

Further, the low friction property of the photoconductor surface reduces the abrasion of a contact portion between the photoconductor and a cleaning blade.

As a result, it is possible to provide an electrophotographic photoconductor having an extremely high-abrasion resistance as well as maintaining good cleanability of a toner over a long period of time, a process cartridge disposing the electrophotographic photoconductor therein, and an electrophotographic apparatus.

(Manufacturing Process)

As a dispersion solvent for preparing a coating liquid of the cross-linked resin surface layer, it is preferable to select a solvent that can dissolve a monomer well. Representative examples thereof include the abovementioned ethers, aromatic compounds, halogens, esters, as well as, cellosolves such as ethoxyethanol, and propylene glycol such as 1-methoxy-2-propanol.

Among them, methylethylketone, tetrahydrofuran, cyclohexanone, and 1-methoxy-2-propanol produce less environmental burdens than chlorobenzene, dichloroethane, toluene, and xylene and, therefore, are preferably used. Theses solvents can be used singularly or in combination as a mixture.

The coating liquid of the cross-linked resin surface layer can be coated typically by dipping, spray coating, ring coating, roll coating, gravure coating, nozzle coating or screen printing. Since the coating liquid has a short pot life in most cases, a coating method that can achieve required coating with a smaller amount of coating liquid is advantageous in terms of environmental consciousness and cost. In this regard, the spray coating and ring coating are preferably used.

In forming the cross-linked resin surface layer, a UV irradiation light source such as high-pressure mercury lamp or metal halide lamp having a light emitting wavelength mainly in the UV region can be used.

In addition, visible light source can be selected according to an absorption wavelength of a radical polymerization containing substance and photopolymerization initiator.

The irradiation amount is preferably from 50 mW/cm² to 1,000 mW/cm². When less than 50 mW/cm², the curing takes much time. When more than 1,000 mW/cm², reaction unevenly proceeds to lead to generation of local corrugation on the cross-linked charge transport layer surface, a lot of unreacted residue, or reaction stopping terminals. Further, an abrupt crosslinking increases an internal stress to thereby cause cracks or film peeling.

If necessary, an antioxidant, a plasticizer, a lubricant, an ultraviolet absorber or similar low molecular compounds and a leveling agent mentioned concerning the charge generating layer and a high-molecular compound mentioned concerning the charge transport layer may be added to the cross-linked resin surface layer. These compounds can be used singularly or in combination as a mixture. There is often the case where simultaneous use of a low molecular compound and leveling agent deteriorates the sensitivity. Therefore, the used amount of the compounds is preferably in a range from 0.1% by mass to 20% by mass, more preferably 0.1% by mass to 10% by mass. The used amount of the leveling agent is preferably in a range from 0.1% by mass to 5% by mass.

The film thickness of the cross-linked resin surface layer is preferably from about 3 μm to 15 μm. The lower limit (3 μm) is a value calculated in view of the effect and cost. The upper limit is set in view of electrostatic characteristics such as electrical charge stability and light attenuation sensitivity, and homogeneity of the film quality.

(Configuration of Electrophotographic Apparatus)

An electrophotographic apparatus used in the present invention will be described below with reference to the accompanying drawings.

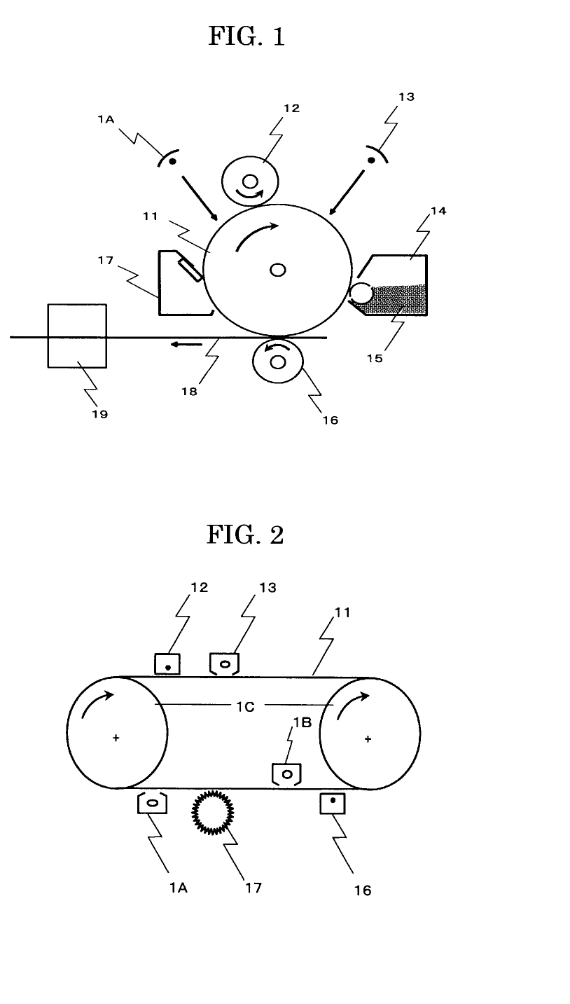

FIG. 1 is a schematic view for explaining an electrophotographic apparatus according to the present invention, and a modified example as described below also belongs to the category of the present invention.

In FIG. 1, a photoconductor 11 is an electrophotographic photoconductor having a cross-linked resin surface layer. The photoconductor 11 has a drum shape, but it may have a sheet-like or endless belt-like shape.

A charging unit 12 employs a known means such as a corotron charger, a scorotron charger, a solid state charger, and a charging roller. From a view point of a reduction in power consumption, the charging member 12 is arranged in contact with or adjacently to the photoconductor. It is desirable to adopt a charging mechanism in which the charging member is adjacently arranged to the surface of photoconductor with an adequate gap. This configuration prevents contamination of the charging member. As a transfer unit 16, the abovementioned chargers can be employed in general. A combination of a transfer charger and separation charger is more preferably used.

As light sources of an exposure unit 13, a charge removing unit 1A and the like, light emission source such as fluorescent lamp, tungsten lamp, halogen lamp, mercury lamp, light emitting diode (LED), semiconductor laser (LD), electroluminescence (EL), and the like are generally used. In order to emit a light of desired wavelength, various filters such as sharp cut filter, band pass filter, near-infrared cut filter, dichroic filer, interference filter, color temperature conversion filter and the like may also be used.

A toner 15 developed on the photoconductor by a developing unit 14 is transferred to a print medium 18 such as a print paper or OHP slide. This toner is not entirely transferred thereto but partially left on the photoconductor. Such a residual toner is removed from the photoconductor with a cleaning unit 17. As the cleaning unit 17, a cleaning blade made of rubber, a fur brush, a magnetic fur brush and the like may be used.

When an electrophotographic photoconductor is positively (negatively) charged in an image exposure, a positive (negative) electrostatic latent image is formed on the surface of photoconductor. This is developed with a toner of negative (positive) polarity (detecting fine particle), whereby a positive image is formed, and developed with a toner of positive (negative) polarity, whereby a negative image is formed. A known method may be applied to such developing unit, and a known method may be used for the charge removing unit.

FIG. 2 shows another example of an electrophotographic process according to the present invention. In FIG. 2, the photoconductor 11 is an electrophotographic photoconductor having a cross-linked resin surface layer. The photoconductor 11 has a belt-like shape, but it may have a drum shape, sheet-like or endless belt-like shape. In the configuration shown in FIG. 2, an electrophotographic process is repeatedly carried out as follows. The photo conductor 11 is first driven by a drive unit 1C, followed by charging the charging unit 12, exposure the exposure unit 13, image developing by a developing unit (not shown), image transfer by a transfer unit 16, pre-cleaning light exposure by a pre-cleaning exposure unit, cleaning by a cleaning unit 17, and removal of electricity by the charge removing unit 1A. In FIG. 2, light irradiation by the pre-cleaning exposure unit 1B is applied to the substrate body side of the photoconductor (in this case, the substrate body is translucent).

The above electrophotographic process exemplifies an embodiment according to the present invention but the present invention is not limited thereto. For example, in FIG. 2, light irradiation by the pre-cleaning exposure unit 1B is applied to the substrate body side of the photoconductor. However, the photoconductive layer side of the photoconductor 11 may also be exposed to the pre-cleaning light. Further, the image exposure light and the charge removing light may be applied to the substrate body side. Meanwhile, it is shown that the photoconductor 11 is exposed to light using the image exposure light, the pre-cleaning light, and the charge removing light. In addition to the above, light exposure may be carried out before image transfer and before image exposure and by other known light exposure processes.

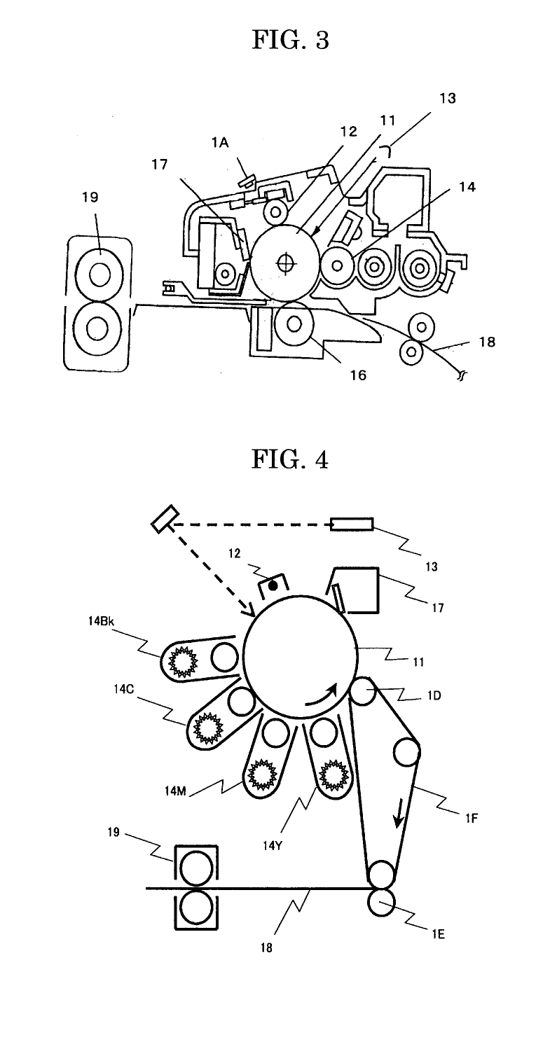

The image forming unit as described above can be fixedly incorporated in a copying machine, facsimile machine, or printer. Alternatively, they can be incorporated as a process cartridge to one of those machines. The process cartridge can take many different shapes and in FIG. 3, there is shown a general embodiment among them. In FIG. 3, the photoconductor 11 has a drum shape, but it may have a sheet-like or endless belt-like shape.

FIG. 4 shows a cross-sectional view of another configuration of the electrophotographic apparatus according to the present invention. In this electrophotographic apparatus, the charging unit 12, exposure unit 13, developing unit 14Bk, 14C, 14M, 14Y corresponding to respective four color toners black (Bk), cyan (C), magenta (M), yellow (Y), intermediate transfer belt 1F serving as an intermediate transfer member, and cleaning member 17 are arranged around the photoconductor 11. The characters of Bk, C, M, and Y shown in FIG. 4 represent the respective toner colors. Theses characters are added or omitted according to need. The photoconductor 11 is an electrophotographic photoconductor having a cross-linked resin surface layer. The respective developing unit 14Bk, 14C, 14M, and 14Y can be controlled in an independent manner, and only the developing unit corresponding to a color to be subjected to image formation is driven. A toner image formed on the photoconductor 11 is transferred onto the intermediate transfer belt 1F by a first transfer unit 1D disposed inner side of the intermediate transfer unit 1F. The first transfer unit 1D can contact or separate from the photoconductor 11 and brings the intermediate transfer belt 1F into contact with the photoconductor 11 only at the time of transfer operation. After image formation of respective colors are sequentially performed, a toner image superimposed on the intermediate transfer belt 1F is transferred onto the print medium 18 by a second transfer unit 1E, and the transferred image is subjected to fixing processing by a fixing unit 19, whereby the image is formed. The second transfer unit 1E is configured to contact or separate from the intermediate transfer belt 1F and is brought into contact with the intermediate transfer belt 1F only at the time of transfer operation.

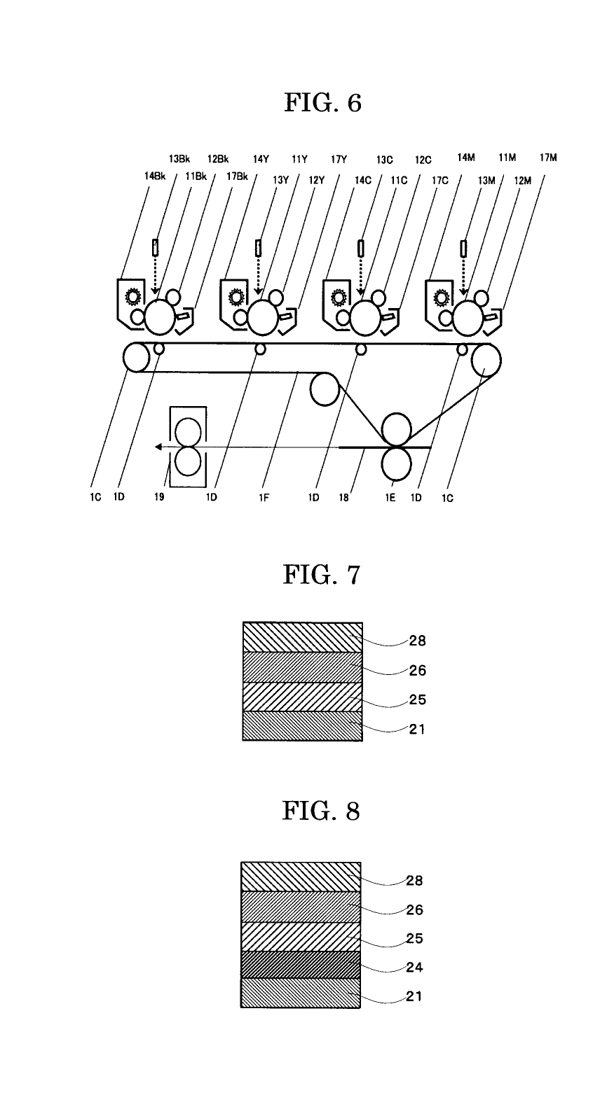

Toner images of respective colors are sequentially transferred onto a transfer member which is electrostatically absorbed to a transfer drum in an electrophotographic apparatus using a transfer drum system, which restricts the type of a transfer material to be used. In this case, for example, a heavy paper cannot be used. On the other hand, in the electrophotographic apparatus using an intermediate transfer system as shown in FIG. 4, toner images of respective colors are superimposed on the intermediate transfer belt 1F, which does not have a restriction on the transfer member. Such an intermediate transfer system can be applied not only to the apparatus shown in FIG. 4, but also to the electrophotographic apparatuses shown in FIGS. 1, 2, 3, and 5 to be described later (whose concrete example is shown in FIG. 6).

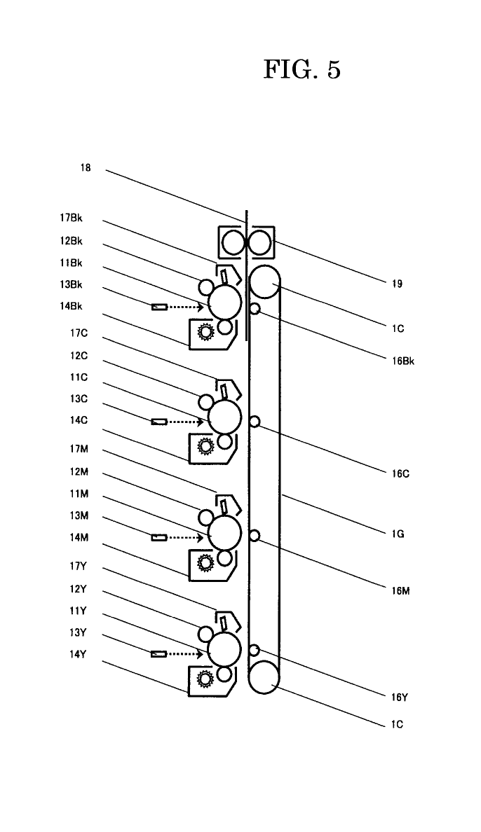

FIG. 5 is a cross-sectional view of another configuration of the electrophotographic apparatus according to the present invention. This electrophotographic apparatus is of a type in which four color toners of yellow (Y), magenta (M), cyan (C), black (Bk) are used and image formation sections are provided for respective colors. Further, photoconductors 11Y, 11M, 11C, 11Bk corresponding to the respective colors are provided. The photoconductor 11 used in this electrophotographic apparatus is an electrophotographic photoconductor having a cross-linked resin surface layer. The charging unit 12, exposure unit 13, developing unit 14, cleaning unit 17 and the like are disposed around each photoconductor 11. A conveyor transfer belt 1G serving as a transfer material carrier which can contact or separate from respective transfer positions of linearly arranged photoconductors 11Y, 11M, 11C, 11Bk is wound around the drive unit 1C. The transfer units 16 are disposed at the transfer positions respectively opposite to the photoconductors 11Y, 11M, 11C, 11Bk across the conveyor transfer belt 1G.

The tandem type electrophotographic apparatus as shown in FIG. 5 has photoconductors 11Y, 11M, 11C, 11Bk and sequentially transfers toner images of respective colors onto the print medium 18 held by the conveyor transfer belt 1G. Thus, it is possible to realize much higher-speed output of a full-color image as compared with a full-color electrophotographic apparatus having only one photoconductor.

According to the present invention, there is provided a practically valuable electrophotographic photoconductor not only having a much higher abrasion resistance but also capable of forming high-quality color image using a polymerization toner and constantly maintaining smoothness of the photoconductor surface.

### EXAMPLES

The following describes the present invention further in detail with reference to Examples, but the present invention is not limited to these Examples.

(Measurement Method)

(1) Calculation of Adhesion Work

A photoconductor is produced by sequentially applying coating and drying to an underlying later, charge generating layer, charge transport layer, and cross-linked resin surface layer. During the production of the photoconductor, a sample in which coating/drying of the underlying later and charge generating layer has been completed and sample in which coating/drying of the underlying later, charge generating layer, and charge transport layer has been completed are extracted. With respect to the above samples and another sample in which coating/curing/drying has been applied to all the layers up to the cross-linked resin surface layer, contact angles of reference materials were measured. The contact angle measurement was carried out using “Automatic Contact Angle Meter CA-W” made by Kyowa interface science Co. Ltd. As the reference materials, ion-exchange water, methylene iodide, and α-bromonaphthalene were selected.

The contact angle measurement values and surface free energy values with respect to the respective reference materials were determined in accordance with the data (Table 1) described in Journal of the Adhesion Society of Japan, 8(3), 131-141 (1972) written by Kitazaki, Hata, et al.) and, based on the data, the adhesive work between the reference materials and samples were calculated.

TABLE 1

| | γ | γ^{a} | γ^{b} | γ_{c} |
|---|---|---|---|---|
| Liquid | (mN/m) | (mN/m) | (mN/m) | (mN/m) |
| Water | 72.8 | 29.1 | 1.3 | 42.4 |
| α-bromonaphthalene | 44.6 | 44.4 | 0.2 | 0 |
| Methylene iodide | 50.8 | 46.8 | 4.0 | 0 |

Subsequently, a simultaneous equation is set up using adhesive forces between methylene iodide/α-bromonaphthalene and samples and the following expression (2).
W₁₂=2\sqrt{γ₁^{a}·γ₂^{a}}+2\sqrt{γ₁^{b}·γ₂^{b}}+2\sqrt{γ₁^{c}·γ₂^{c}} expression (2)

As values of γ₁^{a} and γ₁^{b} of the reference samples, those shown in the data in Table 1 were used and thereby √γ^{a} and √γ^{b} of the samples were calculated.

Subsequently, using the adhesive work between water and photoconductor and the expression (2), √γ^{c} of the samples were calculated.

Based on the obtained √γ^{a}, √γ^{b}, √γ^{c} and the following expression (3), the surface free energy of the photoconductor was calculated.
γ=γ^{a}+γ^{b}+γ^{c} expression (3)

The adhesion works between respective layers were obtained by substituting respective values in the expression (2).

(2) Measurement of Surface Roughness

The center-line surface roughness Ra (JIS B0601; 1982) of the surface of a drum-shaped photoconductor was measured using a stylus type surface roughness tester Surfcom (manufactured by Tokyo Seimitsu Co., Ltd.) with a pickup E-DT-S02A (manufactured by Tokyo Seimitsu Co., Ltd.) attached thereto.

### Example 1

An underlying layer coating liquid, charge generating layer coating liquid, and charge transport layer coating liquid having compositions described below were sequentially applied to an aluminum drum having a radial thickness of 0.8 mm, length of 340 mm, and outer diameter of +30 mm followed by drying, whereby an underlying layer of 3.5 μm thickness, a charge generating layer of 0.2 μm thickness, and a charge transport layer of 22 μm thickness were formed.

Thereafter, a cross-linked resin surface layer coating liquid having the composition described below was applied by spraying on the charge transport layer. Subsequently, UV curing was applied on the resultant charge transport layer with a space of 120 mm provided between a UV curing lamp and photoconductor while the drum is being rotated. The illumination intensity of the UV curing lamp at this time was 600 mW/cm² (measured using an accumulated UV meter, UIT-150 produced by Ushio Inc.).

The rotation speed of the drum was set to 25 rpm. At the time of application of the UV curing, a bar-like metal block was encapsulated in the aluminum drum. In the UV curing, exposure was conducted for 5 minutes in all with exposure of 30 seconds and an interval duration of 120 seconds repeated. After the UV curing, heating and drying were carried out at a temperature of 130° C. for 30 minutes.

Through the above processing, an electrophotographic photoconductor having a cross-linked resin surface layer of 15 μm thickness was obtained.

The surface free energy of the silicone compound used for the cross-linked resin surface layer was 40 mN/m, surface free energy of the silicone compound removing material is 26 mN/m, and wettability between them was 64 mN/m.

[Composition of underlying layer coating liquid]

| | |
|---|---|
| Alkyd resin solution | 12 parts by mass |
| (Beccolite M-6401-50, manufactured by | |
| Dainippon Ink and Chemicals, Inc.) | |
| Melamine resin solution | 8 parts by mass |
| (Super Bekkamine G-821-60, manufactured | |
| by Dainippon Ink and Chemicals, Inc.) | |
| Titanium oxide | 40 parts by mass |
| (CR-EL manufactured by by Ishihara | |
| Sangyo Kaisha Ltd.) | |
| Methyl ethyl ketone | 200 parts by mass |

[Composition of charge generating layer coating liquid]

| | |
|---|---|
| Bis-azo pigment represented by the following structural formula (1) | 5 parts by mass |
| (manufactured by Ricoh Co., Ltd.) | |
| Polyvinyl butyral | 1 part by mass |
| (XYHL, manufactured by UCC Co., Ltd.) | |
| Cyclohexanone | 200 parts by mass |
| Methyl ethyl ketone | 80 parts by mass |

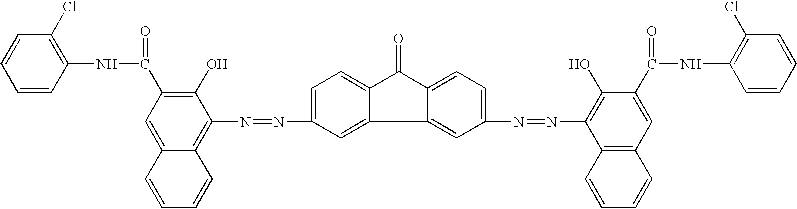

Structural Formula (1)

[Composition of charge transport layer coating liquid]

| | |
|---|---|
| Z-type polycarbonate | 10 parts by mass |
| (Panlite TS-2050″, made by Teijin Chemicals Ltd.) | |
| Low molecular charge transport material represented | 7 parts by mass |
| by the following structural formula (2) | |
| Antioxidant | 0.07 parts by mass |
| (Sumilizer TPS, manufactured by Sumitomo | |
| Chemical Co., Ltd) | |
| Tetrahydrofuran | 100 parts by mass |
| 1% silicone oil tetrahydrofuran solution | 1 parts by mass |
| (1% silicone oil: KF50-100CS, manufactured by | |
| Shin-Etsu Chemical Co., Ltd.) | |

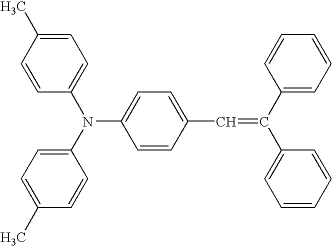

Structural Formula (2)

[Composition of cross-linked resin surface layer coating liquid]

| | |
|---|---|
| Cross-linked charge transport material represented by | 50 parts by mass |
| the following structural formula (3) | |
| Trimethylolpropane triacrylate | 25 parts by mass |
| (KAYARAD TMPTA, manufactured by Nippon | |
| Kayaku Co., Ltd.) | |
| Caprolactone-modified dipentaerithritol hexaacrylate | 25 parts by mass |
| (KAYARD DPCA-120, manufactured by Nippon | |
| Kayaku Co., Ltd.) | |
| Mixture of acrylic group containing polyester modified | 0.1 parts by mass |
| polydimethylsiloxane and propoxy modified-2- | |
| neopentyl glycol diacrylate | |
| (BYK-UV3570, manufactured by BYK Japan K.K.) | |
| 1-hydroxycyclohexyl phenylketone | 5 parts by mass |
| (Irgacure 184, manufactured by Ciba specialty | |
| chemicals) | |
| Silicone compound | 6 parts by mass |
| (X-22-174-DX, manufactured by Shin-Etsu Chemical | |
| Co., Ltd.) | |
| Silicone compound removing material | 6 parts by mass |
| (AFC-G, manufactured by Neos Co., Ltd.) | |
| Tetrahydrofuran | 650 parts by mass |

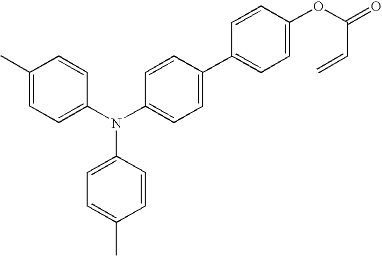

Structural Formula (3)

The electrophotographic photoconductor of Example 1 produced in this manner was adjusted for actual use and disposed in an electrophotographic apparatus (Imagio Neo C455, manufactured by Ricoh Co., Ltd.). Each five copies of a text image and a graphic image with an image density of 5% were continuously produced at a pixel density of 600 dpi×600 dpi for a total of 20,000 copies on copying paper (My paper A4 available from NBS Ricoh Co., Ltd).

As a toner, a black toner for Imagio Neo C455 was used. Similarly, as a developer carrier, a black developer for Imagio Neo C455 was supplied to each of developing station units.

As a photoconductor unit, a genuine product in which a lubricating part contacting a cleaning brush had been removed was used.

The AC component of the voltage applied to the charging roller was set at a peak-to-peak voltage of 1.5 kV at a frequency of 0.9 kHz.

A bias in the DC component thereof was set so that the initial charge potential of the photoconductor at the beginning of the test stands at −700 V, and the test was carried out under this charging condition. The development bias was set at −500 V. This apparatus has no charge-removing unit. A genuine cleaning unit was replaced by new one every 50,000 copies. The test was carried out at 24° C. and 54% RH (relative humidity).

Ten copies of a halftone image, a blank image, and a thin-line image with an image density of 5% at a pixel density of 600 dpi×600 dpi were successively printed out respectively after the completion of the test.

As a result, the outline of the dot images constituting the halftone image was slightly blurred. However, the image blur level was practically nonproblematic. As for the thin-line image, pair lines depicted every one dot could be identified.

Image noise resulting from cleaning defect was not detected on output images.

The surface roughness Rmax of the photoconductors set in the respective developing stations at the test end time was 0.3 μm at maximum, which means that the surface maintains its smoothness. Further, the abrasion amount of the photoconductor surface at the test end time was 1 μm. The static friction coefficient at the test end time was 0.3.

### Comparative Example 1

An electrophotographic photoconductor was obtained in the same manner as Example 1 except that the silicone compound and silicone compound removing material were not contained in the cross-linked resin surface layer coating liquid. The test was carried out in entirely the same manner as Example 1.

As a result, the outline of the dot images constituting the halftone image was slightly blurred. However, the image blur level was practically nonproblematic. As for the thin-line image, pair lines depicted every one dot could be identified.

A linear image noise due to edge damage of the cleaning blade was detected.

The surface roughness Rmax of the photoconductors set in the respective developing stations at the test end time was 0.3 μm at maximum. From the surface observation by a laser microscope, it can be considered that extreme irregularity is caused by a silica component in the developer composition sticking to the photoconductor surface.

### Example 2

An electrophotographic photoconductor was obtained in the same manner as Example 1 except that the composition of the cross-linked resin surface layer coating liquid was changed to the following component. The film thickness of the cross-linked resin surface layer was 3 μm.

[Composition of cross-linked resin surface layer coating liquid]

| | |
|---|---|
| Trimethylolpropane triacrylate | 30 parts by mass |
| (KAYARAD TMPTA, manufactured by Nippon Kayaku Co., | |
| Ltd.) | |
| Cross-linked charge transport material represented by the following | 30 parts by mass |
| structural formula (4) | |
| Melamine | 50 parts by mass |
| | (solid content 30 parts by mass) |
| (Super Bekkamine G-821-60, manufactured by Dainippon Ink | |
| and Chemicals, Inc.) | |
| 1-hydroxycyclohexyl phenylketone | 1.5 parts by mass |
| (Irgacure 184, manufactured by Ciba specialty chemicals) | |
| Silicone compound | 7 parts by mass |
| (X-22-174-DX, manufactured by Shin-Etsu Chemical Co., Ltd.) | |
| Silicone compound removing material | 3 parts by mass |
| (AFC-G, manufactured by Neos Co., Ltd.) | |
| Tetrahydrofuran | 600 parts by mass |

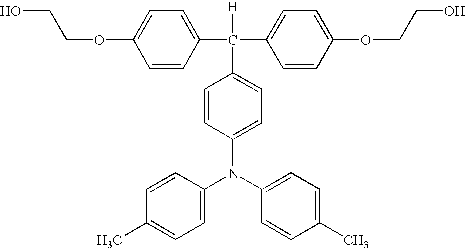

Structual Formula (4)

The electrophotographic photoconductor of Example 1 produced in this manner was adjusted for actual use and disposed in an electrophotographic apparatus (Imagio Neo C455, manufactured by Ricoh Co., Ltd.). Each five copies of a text image and a graphic image with an image density of 5% were continuously produced at a pixel density of 600 dpi×600 dpi for a total of 20,000 copies on copying paper (My paper A4 available from NBS Ricoh Co., Ltd).

As a toner, a black toner for Imagio Neo C455 was used. Similarly, as a developer carrier, a black developer for Imagio Neo C455 was supplied to each of developing station units.

As a photoconductor unit, a genuine product in which a lubricating part contacting a cleaning brush had been removed was used. The AC component of the voltage applied to the charging roller was set at a peak-to-peak voltage of 1.5 kV at a frequency of 0.9 kHz. A bias in the DC component thereof was set so that the charge potential at the beginning of the test stands at −700 V, and the test was carried out under this charging condition. The development bias was set at −500 V.

This apparatus has no charge-removing unit.

At the test, a genuine cleaning unit was replaced by new one every 50,000 copies. The test was carried out at 24° C. and 54% RH (relative humidity).

Ten copies of a halftone image, a blank image, and a thin-line image with an image density of 5% at a pixel density of 600 dpi×600 dpi were successively printed out respectively after the completion of the test.

As a result, the outline of the dot images constituting the halftone image was clear, and there is no problem for actual use. As for the thin-line image, pair lines depicted every one dot could be identified.

Image noise resulting from cleaning defect was not detected on output images.

The surface roughness Rmax of the photoconductors set in the respective developing stations at the test end time was 0.6 μm at a maximum, which means that the surface maintains its smoothness. Further, the abrasion amount of the photoconductor surface at the test end time was 1.4 μm. The static friction coefficient at the test end time was 0.2.

### Comparative Example 2

An electrophotographic photoconductor was obtained in the same manner as Example 2 except that the silicone compound and silicone compound removing material were not contained in the cross-linked resin surface layer coating liquid. The test was carried out in entirely the same manner as Example 2.

As a result, the outline of the dot images was clear, and there is no problem for actual use.

A linear image noise due to edge damage of the cleaning blade was detected.

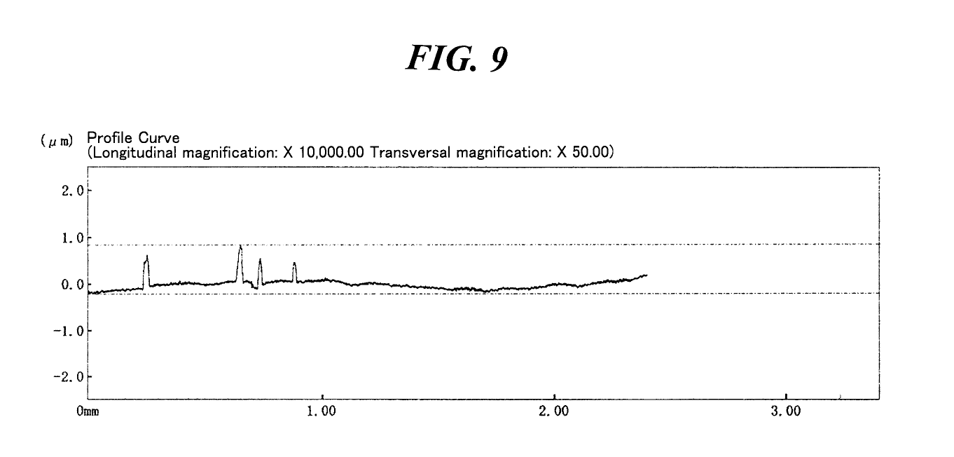

The surface roughness Rmax of the photoconductors set in the respective developing stations at the test end time was 1.9 μm at maximum. Although the value of the Rmax is not so high, a profile curve similar to that shown in FIG. 9 was obtained. The static friction coefficient at the test end time was 0.6.

### Example 3

An electrophotographic photoconductor was obtained in the same manner as Example 2 except that the component of the cross-linked charge transport material in the composition of the cross-linked resin surface layer coating liquid was changed to the component represented by the following structural formula (5). The test was carried out in entirely the same manner as Example 2.

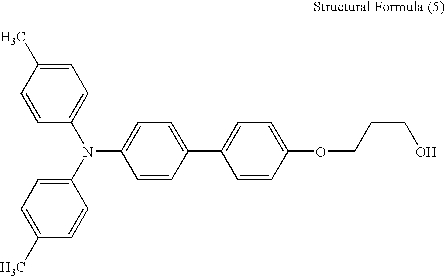

As a result, the outline of the dot images was clear, and there is no problem for actual use. As for the thin-line image, pair lines depicted every one dot could be identified.

Image noise resulting from cleaning defect was not detected on output images.

The surface roughness Rmax of the photoconductors set in the respective developing stations at the test end time was 0.2 μm at maximum, which means that the surface maintains its smoothness. Further, the abrasion amount of the photoconductor surface at the test end time was 1.3 μm. The static friction coefficient at the test end time was 0.3.

### Comparative Example 3

An electrophotographic photoconductor was obtained in the same manner as Example 3 except that the silicone compound and silicone compound removing material were not contained in the cross-linked resin surface layer coating liquid. The test was carried out in entirely the same manner as Example 3.

As a result, the outline of the dot images was clear, and there is no problem for actual use. As for the thin-line image, pair lines depicted every one dot could be identified.

A linear image noise due to edge damage of the cleaning blade was detected.

The surface roughness Rmax of the photoconductors set in the respective developing stations at the test end time was 1.1 μm at maximum, and a profile curve similar to that shown in FIG. 9 was obtained. The abrasion amount of the photoconductor surface at the test end time was 1.2 μm. The static friction coefficient at the test end time was 0.6.

### Example 4

An underlying layer coating liquid, charge generating layer coating liquid, and charge transport layer coating liquid having compositions described below were sequentially applied to an aluminum drum having a radial thickness of 0.8 mm, length of 340 mm, and outer diameter of 30 mm followed by drying, whereby an underlying layer of 3.5 μm thickness, a charge generating layer of 0.2 μm thickness, and a charge transport layer of 22 μm thickness were formed.

Thereafter, a cross-linked resin surface layer coating liquid having the composition described below was applied by spraying on the charge transport layer. Subsequently, UV curing was applied on the resultant charge transport layer with a space of 120 mm provided between a UV curing lamp and photoconductor while the drum is being rotated. The illumination intensity of the UV curing lamp at this time was 600 mW/cm² (measured using an accumulated UV meter, UIT-150 produced by Ushio Denki Co., Ltd.). The rotation speed of the drum was set to 25 rpm. At the time of application of the UV curing, a bar-like metal block was encapsulated in the aluminum drum. In the UV curing, exposure was conducted for 4 minutes in all with exposure of 30 seconds and an interval duration of 120 seconds repeated. After the UV curing, heating and drying were carried out at a temperature of 130° C. for 30 minutes. As a result, an electrophotographic photoconductor having a cross-linked resin surface layer of 7 μm thickness was obtained.

[Composition of underlying layer coating liquid]

| | |
|---|---|
| Alkyd resin solution | 12 parts by mass |
| (Beccolite M-6401-50, manufactured by | |
| Dainippon Ink and Chemicals, Inc.) | |
| Melamine resin solution | 8 parts by mass |
| (Super Bekkamine G-821-60, manufactured | |
| by Dainippon Ink and Chemicals, Inc.) | |
| Titanium oxide | 40 parts by mass |
| (CR-EL manufactured by Ishihara Sangyo | |
| Kaisha Ltd.) | |
| Methyl ethyl ketone | 200 parts by mass |

[Composition of charge generating layer coating liquid]

| | |
|---|---|
| Titanyl phthalocyanine | 20 parts by mass |
| (manufactured by Ricoh Co., Ltd.) | |
| Polyvinyl alcohol | 10 parts by mass |
| (S-lec B BX-1, manufactured by Sekisui | |
| Chemical Co., Ltd.) | |
| Methyl ethyl ketone | 100 parts by mass |

[Composition of charge transport layer coating liquid]

| | |
|---|---|
| Z-type polycarbonate | 10 parts by mass |
| (Panlite TS-2050″, made by Teijin Chemicals Ltd.) | |
| Low molecular charge transport material represented | 9.5 parts by mass |
| by the following structural formula (6) | |
| Compound represented by the following structural | 0.5 parts by mass |
| formula (7) | |
| Tetrahydrofuran | 100 parts by mass |
| 1% silicone oil tetrahydrofuran solution | 1 part by mass |
| (1% silicone oil: KF50-100CS, manufactured by Shin- | |
| Etsu Chemical Co., Ltd.) | |

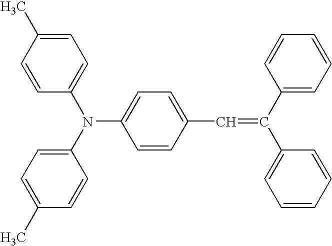

Structual Formula (6)

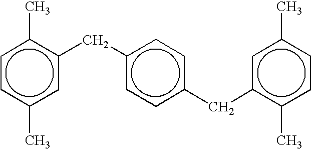

Structual Formula (7)

[Composition of cross-linked resin surface layer coating liquid]

| | |
|---|---|
| Cross-linked charge transport material represented by | 50 parts by mass |
| the following structural formula (8) | |
| Trimethylolpropane triacrylate | 25 parts by mass |
| (KAYARAD TMPTA, manufactured by Nippon | |
| Kayaku Co., Ltd.) | |
| Caprolactone-modified dipentaerithritol hexaacrylate | 25 parts by mass |
| (KAYARD DPCA-120, manufactured by Nippon | |
| Kayaku Co., Ltd.) | |
| Mixture of acrylic group containing polyester modified | 0.1 parts by mass |
| polydimethylsiloxane and propoxy modified-2- | |
| neopentyl glycol diacrylate | |
| (BYK-UV3570, manufactured by BYK Japan K.K.) | |
| Silicone compound | 3 parts by mass |
| (X-22-174-DX, manufactured by Shin-Etsu Chemical | |
| Co., Ltd.) | |
| Silicone compound removing material | 5 parts by mass |
| (AFC-G, manufactured by Neos Co., Ltd.) | |
| Tetrahydrofuran | 650 parts by mass |

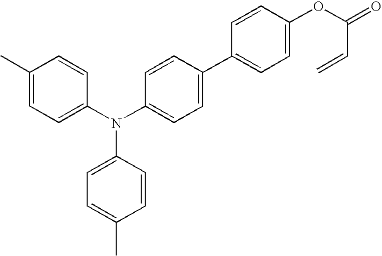

Structual Formula (8)

The electrophotographic photoconductor of Example 4 produced in this manner was adjusted for actual use and disposed in an electrophotographic apparatus (Imagio Neo C455, manufactured by Ricoh Co., Ltd.). Each five copies of a text image and a graphic image with an image density of 5% were continuously produced at a pixel density of 600 dpi×600 dpi for a total of 20,000 copies on copying paper (My paper A4 available from NBS Ricoh Co., Ltd).

As a toner, a black toner for Imagio Neo C455 was used. Similarly, as a developer carrier, a black developer for Imagio Neo C455 was supplied to each of developing station units.

As a photoconductor unit, a genuine product in which a lubricating part contacting a cleaning brush had been removed was used.

The AC component of the voltage applied to the charging roller was set at a peak-to-peak voltage of 1.5 kV at a frequency of 0.9 kHz. A bias in the DC component thereof was set so that the initial charge potential at the beginning of the test stands at −700 V, and the test was carried out under this charging condition. The development bias was set at −500 V. This apparatus has no charge-removing unit. A genuine cleaning unit was replaced by new one every 50,000 copies.

The test was carried out at 24° C. and 54% RH (relative humidity).

Ten copies of a halftone image, a blank image, and a thin-line image with an image density of 5% at a pixel density of 600 dpi×600 dpi were successively printed out respectively after the completion of the test.

As a result, the outline of the dot images constituting the halftone image was slightly blurred. However, the image blur level was practically nonproblematic. As for the thin-line image, pair lines depicted every one dot could be identified.

As image noise resulting from cleaning defect, very slight background stain was detected. However, the image noise level was practically nonproblematic.

The surface roughness Rmax of the photoconductors set in the respective developing stations at the test end time was 0.9 μm at maximum, which means that the surface maintains its smoothness.

Further, the abrasion amount of the photoconductor surface at the test end time was 1.4 μm. The static friction coefficient at the test end time was 0.4.

### Example 5

An electrophotographic photoconductor was obtained in the same manner as Example 4 except that the component of the composition of the cross-linked resin surface layer coating liquid was changed to the component described below. The test was carried out in entirely the same manner as Example 4.

[Composition of cross-linked resin surface layer coating liquid]

| | |
|---|---|
| Cross-linked charge transport material represented by | 50 parts by mass |
| the following structural formula (9) | |
| Trimethylolpropane triacrylate | 25 parts by mass |
| (KAYARAD TMPTA, manufactured by Nippon | |
| Kayaku Co., Ltd.) | |
| Caprolactone-modified dipentaerithritol hexaacrylate | 25 parts by mass |
| (KAYARD DPCA-120, manufactured by Nippon | |
| Kayaku Co., Ltd.) | |
| Mixture of acrylic group containing polyester modified | 0.1 parts by mass |
| polydimethylsiloxane and propoxy modified-2- | |
| neopentyl glycol diacrylate | |
| (BYK-UV3570, manufactured by BYK Japan K.K.) | |
| Silicone compound | 15 parts by mass |
| (X-22-174-DX, manufactured by Shin-Etsu Chemical | |
| Co., Ltd.) | |
| Silicone compound removing material | 7 parts by mass |
| (AFC-G, manufactured by Neos Co., Ltd.) | |
| Tetrahydrofuran | 650 parts by mass |

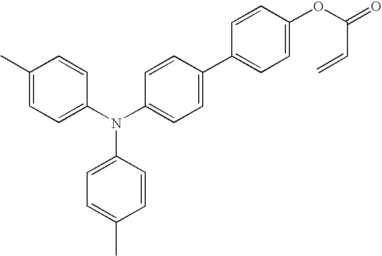

Structual Formula (9)

As a result, the outline of the dot images constituting the halftone image was slightly blurred. Although the image blur level was practically nonproblematic, image density was slightly low. Thus, the obtained halftone image was far from high-quality. As for the thin-line image, pair lines depicted every four dots could be identified, whereas pair lines depicted every one dot could not be identified.

Image noise resulting from cleaning defect was not detected on output images.

The surface roughness Rmax of the photoconductors set in the respective developing stations at the test end time was 0.3 μm at maximum, which means, at least, that the surface maintains its smoothness. Further, the abrasion amount of the photoconductor surface at the test end time was 1.9 μm.

### Example 6

An electrophotographic photoconductor was obtained in the same manner as Example 4 except that the component of the composition of the cross-linked resin surface layer coating liquid was changed to the component described below. The test was carried out in entirely the same manner as Example 4.

[Composition of cross-linked resin surface layer coating liquid]

| | |
|---|---|
| Cross-linked charge transport material represented by | 50 parts by mass |
| the following structural formula (10) | |
| Trimethylolpropane triacrylate | 25 parts by mass |
| (KAYARAD TMPTA, manufactured by Nippon | |
| Kayaku Co., Ltd.) | |
| Caprolactone-modified dipentaerithritol hexaacrylate | 25 parts by mass |
| (KAYARD DPCA-120, manufactured by Nippon | |
| Kayaku Co.,Ltd.) | |
| Mixture of acrylic group containing polyester modified | 0.1 parts by mass |
| polydimethylsiloxane and propoxy modified-2- | |
| neopentyl glycol diacrylate | |
| (BYK-UV3570, manufactured by BYK Japan K.K.) | |
| Silicone compound | 10 parts by mass |
| (X-22-174-DX, manufactured by Shin-Etsu Chemical | |
| Co., Ltd.) | |
| Silicone compound removing material | 1 part by mass |
| (AFC-G, manufactured by Neos Co., Ltd.) | |
| Tetrahydrofuran | 650 parts by mass |

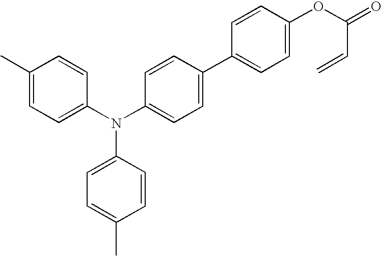

Structual Formula (10)

As a result, the outline of the dot images constituting the halftone image was slightly blurred. As for the thin-line image, pair lines depicted every four dots could be identified, whereas pair lines depicted every one dot could be identified.

Although image noise resulting from cleaning defect was slightly detected, the noise level was practically nonproblematic.

The surface roughness Rmax of the photoconductors set in the respective developing stations at the test end time was 0.7 μm at a maximum, which means, roughly, that the surface maintains its smoothness. Further, the abrasion amount of the photoconductor surface at the test end time was 1.0 μm. The static friction coefficient at the test end time was 0.4.

### Example 7

An electrophotographic photoconductor was obtained in the same manner as Example 4 except that the component of the composition of the cross-linked resin surface layer coating liquid was changed to the component described below. The test was carried out in entirely the same manner as Example 4.

[Composition of cross-linked resin surface layer coating liquid]

| | |
|---|---|
| Cross-linked charge transport material represented by | 50 parts by mass |
| the following structural formula (11) | |
| Trimethylolpropane triacrylate | 25 parts by mass |
| (KAYARAD TMPTA, manufactured by Nippon | |
| Kayaku Co., Ltd.) | |
| Caprolactone-modified dipentaerithritol hexaacrylate | 25 parts by mass |
| (KAYARD DPCA-120, manufactured by Nippon | |
| Kayaku Co., Ltd.) | |
| Mixture of acrylic group containing polyester modified | 0.1 parts by mass |
| polydimethylsiloxane and propoxy modified-2- | |
| neopentyl glycol diacrylate | |
| (BYK-UV3570, manufactured by BYK Japan K.K.) | |
| Silicone compound | 7 parts by mass |
| (X-22-174-DX, manufactured by Shin-Etsu Chemical | |
| Co., Ltd.) | |
| Silicone compound removing material | 15 parts by mass |
| (AFC-G, manufactured by Neos Co., Ltd.) | |
| Tetrahydrofuran | 650 parts by mass |

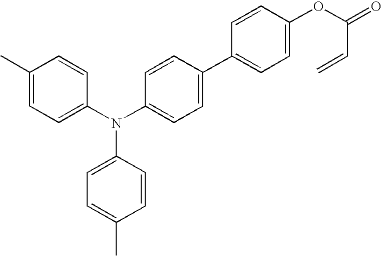

Structual Formula (11)

As a result, the outline of the dot images constituting the halftone image was slightly blurred. Although the image blur level was practically nonproblematic, image density was slightly low. Thus, the obtained halftone image was far from high-quality. As for the thin-line image, pair lines depicted every four dots could be identified, whereas pair lines depicted every one dot could not be identified.

Although image noise resulting from cleaning defect was slightly detected, the noise level was practically nonproblematic.

The surface roughness Rmax of the photoconductors at the test end time was smooth. Further, the abrasion amount of the photoconductor surface at the test end time was 2.0 μm.

According to the present invention, there is provided a practically valuable electrophotographic photoconductor not only having a much higher abrasion resistance but also capable of forming high-quality color image using a polymerization toner and constantly maintaining smoothness of the photoconductor surface.

What is claimed is:

1. An electrophotographic photoconductor comprising at least:
a conductive substrate;
a photoconductive layer comprising a charge generating material and charge transport material, disposed on the conductive substrate; and
a surface layer disposed on the photoconductive layer,
wherein the surface layer is a cross-linked resin which comprises at least:
trimethylolpropane triacrylate;
a charge transport material having a heat-curable or radical-polymerizable functional group;
a silicone compound having a radical-polymerizable functional group;
a fluorinated surfactant having a radical-polymerizable functional group; and
a silicone compound removing material having a radical-polymerizable functional group having a wettability of 55 mN/m or more to less than 65 mN/m with the silicone compound.

2. The electrophotographic photoconductor according to claim 1, wherein the silicone compound removing material is a fluorinated surfactant.

3. The electrophotographic photoconductor according to claim 1, wherein the surface layer comprise a cross-linked body of at least one curable charge transport materials represented by the following general formulas 1 to 3 at an amount of 5% by mass or more to less than 60% by mass, 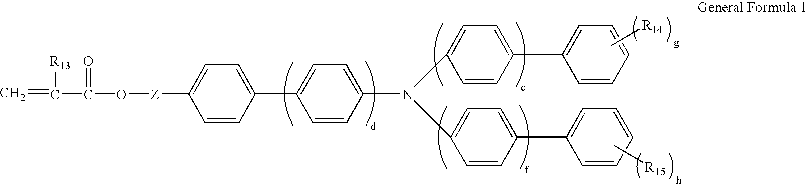
in this general formula 1 d, e and f each represent an integer of 0 or 1; R¹³ represents a hydrogen atom or a methyl group; each of R₁₄ and R₁₅ represents a substituent other than a hydrogen atom which is a C₁₋₆ alkyl group and R₁₄ and R₁₅ are identical or different to each other; g and h represent an integer of 0 to 3; and Z represents a single bond, a methylene group, an ethylene group, or any of groups expressed by the following formulae, 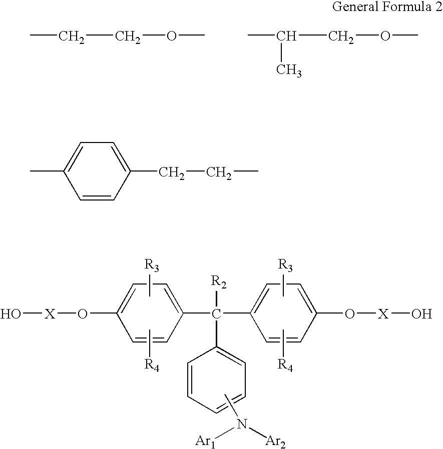
in the general formula 2, R₂, R₃, and R₄ respectively represent a hydrogen atom, a substituted or unsubstituted alkyl group, or an aryl group; Ar₁ and Ar₂ respectively represent an aryl group; and X represents one of the following (a) to (c),
(a) an alkylene group,
(b) an arylene group, and
(c) a group represented by the following general formula 4, 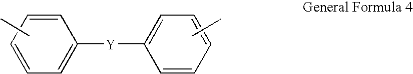
in the general formula 4, Y represents —O—, —S—, —SO—, —SO₂—, —CO—, and the following divalent groups, 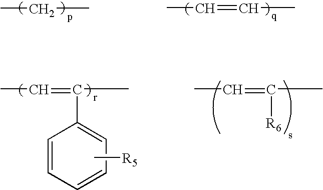
in the formulae, R₅ and R₆ respectively represent a hydrogen atom, an alkyl group, an alkoxy group, a halogen atom, an aryl group, an amino group, a nitro group, or cyano group; and p, q, r, s are each an integer of from 1 to 12, 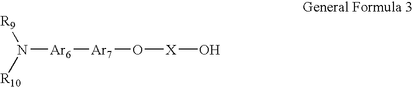
in the general formula 3, R₉ and R₁₀ respectively represent a substituted or unsubstituted aryl group, and R₉ and R₁₀ are the same or different; an arylene group represented by Ar₆ and Ar₇ is a divalent group of the same aryl group as R₉ and R₁₀, which are the same or different; and X is the same as that shown in the above general formula 2.

4. The electrophotographic photoconductor according to claim 1, wherein an amount of the silicone compound is 0.5% by mass to 15% by mass with respect to a total solids mass of a coating liquid of the surface layer.

5. The electrophotographic photoconductor according to claim 1, wherein an amount of the silicone compound removing material is 0.5% by mass to 15% by mass with respect to a total solids mass of a coating liquid of the surface layer.

6. The electrophotographic photoconductor according to claim 5, wherein the amount of the silicone compound removing material is 1% by mass to 10% by mass with respect to the total solids mass of the coating liquid of the surface layer.

7. A process cartridge comprising:
an electrophotographic photoconductor disposed in the process cartridge,
wherein the electrophotographic photoconductor at least comprising on a conductive substrate body thereof: a photoconductive layer containing at least a charge generating material and charge transport material; and a surface layer, the surface layer being a cross-linked resin which at least contains: trimethylolpropane triacrylate; a charge transport material having a heat-curable or radical-polymerizable functional group; a silicone compound having a radical-polymerizable functional group; a fluorinated surfactant having a radical-polymerizable functional group; and a silicone compound removing material having a radical-polymerizable functional group having a wettability of 55 mN/m or more to less than 65 mN/m with the silicone compound.

8. An electrophotographic apparatus comprising at least:
an electrophotographic photoconductor; and
a process cartridge disposing the electrophotographic photoconductor therein,
wherein the electrophotographic photoconductor comprises at least: a conductive substrate; a photoconductive layer containing a is charge generating material and charge transport material; and a surface layer, the surface layer being a cross-linked resin which at least contains: trimethylolpropane triacrylate; a charge transport material having a heat-curable or radical-polymerizable functional group; a silicone compound having a radical-polymerizable functional group; a fluorinated surfactant having a radical-polymerizable functional group; and a silicone compound removing material having a radical-polymerizable functional group having a wettability of 55 mN/m or more to less than 65 mN/m with the silicone compound.

9. The electrophotographic apparatus according to claim 8, wherein the electrophotographic apparatus has developing units for two or more colors, employs a tandem system, and performs developing using a polymerization toner.
